(19) United States
(12) Patent Application Publication
(10) Pub. No.: US 2010/0010891 A1
(43) Pub. Date: Jan. 14, 2010

(54) METHODS FOR ADVERTISEMENT SLATE SELECTION

(75) Inventors: John Langford, White Plains, NY (US); Tong Zhang, Tuckahoe, NY (US)

Correspondence Address: MPG, LLP AND YAHOO! INC., 710 LAKEWAY DRIVE, SUITE 200, SUNNYVALE, CA, 94085, US

(73) Assignee: Yohoo! Inc., Sunnyvale, CA (US)

(21) Appl. No.: 12/104,418

(22) Filed: Apr. 16, 2008

(51) Int. Cl. G06Q 30/00

(52) U.S. Cl. 705/14.46; 705/14.69; 705/14.71

(57) ABSTRACT

A computer implemented method is disclosed for controlling display of advertisements. The method includes selecting a policy that generates a slate of advertisements to be displayed when the policy is applied to a context. The method also includes applying the selected policy to the context to generate the slate of advertisements to be displayed, and displaying the slate of advertisements. The method further includes identifying a user-selected advertisement in the slate of advertisements, and calculating a cost of the user-selected advertisement to be charged to an owner of the advertisement. The cost is calculated based on the selected policy, the context, and the slate of advertisements.

### BACKGROUND OF THE INVENTION

It is common for a website to allocate display space for paid advertisements (ads) as a means of generating revenue. However, because the number of ads available for display can significantly exceed the number of advertisement (ad) spaces available, it is necessary to select a particular set of ads for display. In general, when a displayed ad is clicked-on by a user, an owner of the clicked-on ad is charged a fee for having the corresponding ad displayed. Therefore, because a given ad generates revenue when it is clicked-on by a user, it is preferable to select ads for display that have a higher likelihood of being clicked-on.

The likelihood that a particular ad is clicked-on by a user is quantified by a click-through-rate (CTR) parameter, where the CTR is equal to an expected fraction of clicks on a particular ad in a particular context per display event. Conventional techniques for selecting a set of ads for display relies upon direct calculation of the CTR for each of the ads available for display. However, direct calculation of CTR for a given ad can be quite difficult, if not impossible. For example, because the CTR of a particular ad is very small, small errors in the CTR of a particular ad can cause dramatic adverse changes in a set of ads selected for display.

In view of the foregoing, a method is sought for selecting a set of ads for display without relying upon direct calculation of the CTR for each available ad.

### SUMMARY OF THE INVENTION

In one embodiment, a computer implemented method is disclosed for controlling display of advertisements. The method includes an operation for selecting a policy that generates a slate of advertisements to be displayed when the policy is applied to a context. The method also includes an operation for applying the selected policy to the context to generate the slate of advertisements to be displayed. The method further includes displaying the slate of advertisements. An operation is then performed to identify a user-selected advertisement in the slate of advertisements. The method also includes an operation for calculating a cost of the user-selected advertisement to be charged to an owner of the advertisement. The cost is calculated based on the selected policy, the context, and the slate of advertisements.

In another embodiment, a computer implemented method is disclosed for selecting a policy to be used to determine an advertisement slate for display. The method includes an operation for establishing a number of policies. The method also includes an operation for applying each of the number of policies to historical data to determine a revenue amount that would have been generated by each of the number of policies. The method further includes an operation for selecting a policy, from the number of policies, that provides a largest revenue amount when applied to the historical data. The selected policy is to be used to determine an advertisement slate for display in a current context.

In another embodiment, a computer implemented method is disclosed for pricing a user-selected advertisement. The method includes an operation for identifying a user-selected advertisement in a displayed slate of advertisements. The method also includes an operation for varying a bid amount of the user-selected advertisement within a range extending downward from a maximum bid amount of the user-selected advertisement. The maximum bid amount is specified by an owner of the user-selected advertisement. The method further includes an operation for determining whether each variation in the bid amount of the user-selected advertisement causes a change in the displayed slate of advertisements. The method also includes an operation for identifying a lowest bid amount of the user-selected advertisement, from the variations in the bid amount, that does not cause a change in the displayed slate of advertisements. The method further includes an operation for assigning the identified lowest bid amount of the user-selected advertisement as a cost of the user-selected advertisement to be charged to the owner of the user-selected advertisement.

Other aspects and advantages of the invention will become more apparent from the following detailed description, taken in conjunction with the accompanying drawings, illustrating by way of example the present invention.

### BRIEF DESCRIPTION OF THE DRAWINGS

FIG. 1 is an illustration showing a search page in which a slate of ads is displayed in conjunction with search results, in accordance with one embodiment of the present invention;

FIG. 2 is an illustration showing a flowchart of a method for controlling display of advertisements, in accordance with one embodiment of the present invention;

FIG. 3A is an illustration showing a flowchart of a method for selecting a policy to be used to determine an advertisement slate for display, in accordance with one embodiment of the present invention;

FIG. 3B is an illustration showing an expanded description of the operation for applying each of the number of policies to historical data to determine a revenue amount that would have been generated by each of the number of policies, in accordance with one embodiment of the present invention; and

FIG. 4 is an illustration showing a flowchart of a method for pricing a user-selected advertisement, in accordance with one embodiment of the present invention.

### DETAILED DESCRIPTION

In the following description, numerous specific details are set forth in order to provide a thorough understanding of the present invention. It will be apparent, however, to one skilled in the art that the present invention may be practiced without some or all of these specific details. In other instances, well known process operations have not been described in detail in order not to unnecessarily obscure the present invention.

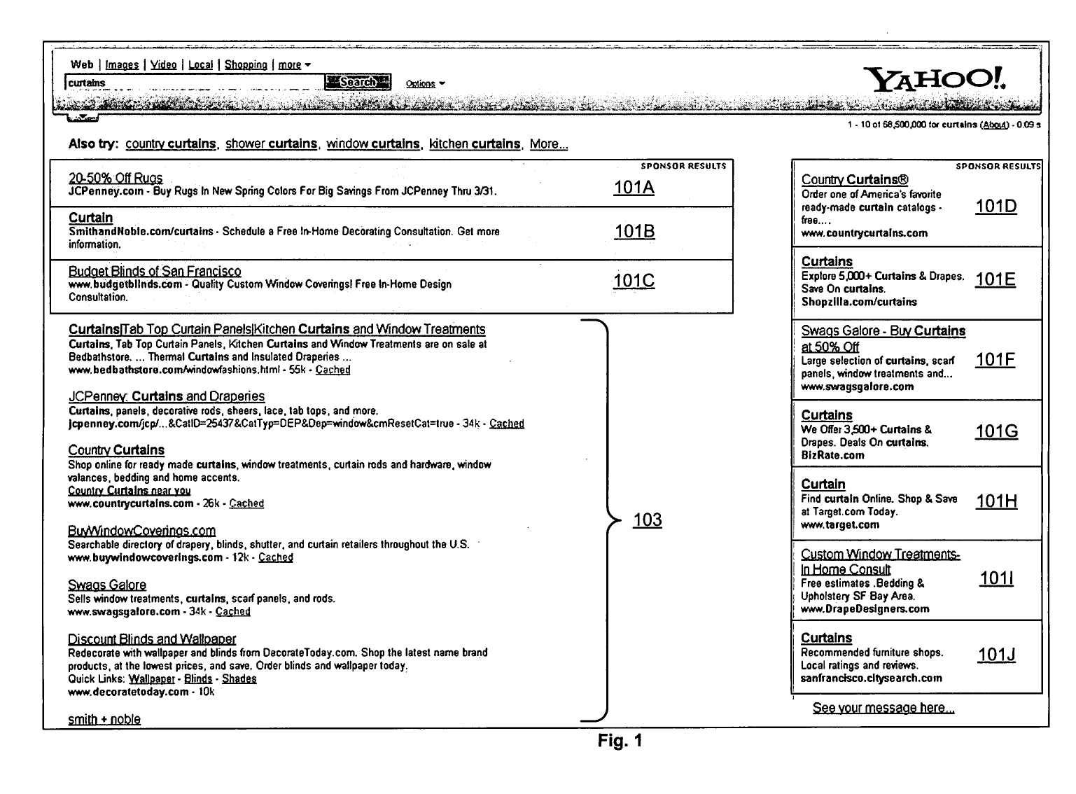

One technique for generating revenue through a webpage is to display advertisements (ads) within allocated spaces on the webpage and to charge an advertisement (ad) owner a fee whenever their ad is clicked-on by a user. For example, FIG. 1 is an illustration showing a search page in which a slate of ads is displayed in conjunction with search results 103, in accordance with one embodiment of the present invention. The sponsored ads which occupy the allocated spaces 101A through 101J in the search page of FIG. 1 define the slate of ads. Each ad in the slate of ads is selected from an available population of ads.

An objective in selecting the slate of ads is to select a slate of ads that will optimize revenue generation. Because revenue is generated by an ad when a user clicks on the ad, i.e., when a user selects the ad, a corresponding objective in selecting the slate of ads to display is to select ads that have a high likelihood of being clicked-on by a user. However, as discussed below, the revenue generation capability of a given ad is a function of both the likelihood of a user click on the given ad and a bid amount associated with the given ad, wherein the bid amount of the given ad represents a maximum fee that may be charged per click on the given ad. Therefore, to optimize revenue generation through the slate of ads, it is appropriate to select ads that are both likely to be clicked-on by a user in a given context, and that have a relatively high bid amount compared to other available ads. To this end, a method is disclosed herein for selecting a slate of ads to be displayed so as to optimize revenue generation. However, before delving into the method, a number of associated definitions and concepts are described.

An ad (α) is defined to have a content (c). The ad (α) is also defined to have a bid (b) that is linked to a budget (B). Therefore, the ad (α) can be represented as α=(b,B,c). Also, the bid of an ad (α) is referred to as b_{α}.

A context (x) is defined generally as every bit of information which is available and helpful in predicting which ad to display. The context (x) may include (but is not limited to): 1) a query by a user, 2) past queries by the same user, 3) a content (c) of the available ads, 4) a location of the user, 5) past purchases by the user, 6) a time of day/week/month/year, and/or 7) a set of ads available. The context (x) may be represented in a number of forms. For example, the context (x) may be represented as a vector of bits which encode the context information. However, it should be understood that the methods described herein are equally applicable to any context (x), regardless of the form in which the context (x) is represented.

A policy (π) is defined as a function on the context (x) that orders ads. More specifically, the term πᵢ(x) represents the ad (αᵢ) that is placed by the policy (π) at the i-th position in the ordering of ads, when the policy (z) is applied to the context (x). In one embodiment, the policy (π) is also defined to determine how many ads are to be displayed. However, it should be understood that in other embodiments the policy (π) is not required to determine how many ads are to be displayed.

Each ad has an associated ad revenue (r) when clicked-on by a user. The ads are ordered α₁, . . . , αₙ, by the policy (π) applied to the context (x), with a revenue for the i-th ad of rᵢ(x,π) for clicking on ad (αᵢ). The revenue rᵢ(x,π) for clicking on ad (αᵢ) is upper bounded by the bid amount (bᵢ) for ad (αᵢ). Also, as described below in a method for pricing a user-selected ad, the revenue rᵢ(x,π) for clicking on ad (αᵢ) is a function of the other ads in the displayed slate of ads, and is not dependent on the bid amount (bᵢ) for ad (αᵢ), although it is capped by the bid amount (bᵢ) for ad (αᵢ).

In a process of selecting a slate ads for display, a current context (x) is drawn from an unknown distribution D. The context (x) includes the set of available ads {α}, represented as Aₓ. A policy (π) is used to order the ads in Aₓ. The slate of ads to be displayed is selected from the beginning of the ordered ads in Aₓ. A set of user clicks (c₁, . . . , cₙ) are received. The set of user clicks (cₗ, . . . , cₙ) respectively correspond to the ordered set of ads (αₗ, . . . , αₙ). Also, the set of user clicks (cₗ, . . . , cₙ) is drawn according to some unknown distribution (P|x, αₗ, . . . , αₙ). Each user click variable (cᵢ) can have a state of 1 or 0, wherein the state of a user click variable (cᵢ) is 1 if the user clicks on the ad (αᵢ) at position (i) in the ordered set of ads (αₗ, . . . , αₙ), and 0 otherwise. Because a limited number of ad spaces are available in a given display, i.e., in a given ad slate, only a limited number of ads at the beginning of the ordered set of ads (αₗ, . . . , αₙ) will be displayed at a given time. The state of the user click variable (cᵢ) for each non-displayed ad is 0. The revenue generated by each ad in the displayed slate of ads equals rᵢ(x,π) if cᵢ=1, and equals 0 if cᵢ=0.

An expected revenue (ER_{π}) of a given policy (π) is represented as shown in Equation 1, wherein (E_{x˜D}) is an expectation that a given context (x) is drawn from some distribution D, wherein P(cᵢ=1|x,αₗ, . . . , αₙ) is a probability that a given ad (as) is clicked by a user in the given context (x), and wherein rᵢ(x,π) is a revenue generated by the given ad (αᵢ) when clicked on in the displayed slate of ads as ordered by the policy (π) operating on the given context (x). It is desirable to maximize the expected revenue (ER_{π}). Therefore, an objective is to optimize a policy (π) that will maximize the expected revenue (ER_{π}).

$$E {R}_{π} = {\sum }_{i = 1}^{n} {E}_{x ∼ D} P ( {c}_{i} = 1 \vert x , {a}_{1} , … , {a}_{n} ) {r}_{i} ( x , π ) . \qquad Equation 1$$

Due to the difficulty associated with directly estimating the click-through-rate (CTR) probability for a given ad, particularly when the CTR probability is context dependent and ad display position dependent, it is of interest to have a method for optimizing the policy (π) so as to maximize the expected revenue (ER_{π}) without requiring a direct, i.e., explicit, calculation of CTR probability for a given ad. To this end, methods are disclosed herein to enable optimization of an ad ranking/pricing policy (π), with regard to revenue generation, without required direct calculation of CTR probability for a given ad.

A first consideration in separating CTR probability estimation from policy (π) optimization is economics. Each policy (π) has an associated implicit generalized second price auction. The implicit generalized second price auction is defined as follows. For application of an arbitrary policy (π) to a given context (x) so as to place an ad (αᵢ) in the i-th position, a financial reward is determined for a click on the ad (αᵢ). First, the bid (bᵢ) of ad (αᵢ) is altered to a bid (bᵢ′), thereby defining a perturbation of the context (x), which is represented as z(x,α,bᵢ′). For example, if x={u, {α}}, where (u) denotes other context, and {α=(b,B,c)} is a set of ads, then x_{α′b′}={u,{α}}, where α′=(b′,B,c) for the ad αᵢ=α′. In other words, the context (X_{α′b′}) is the same as the context (x) except that the bid of ad (αᵢ) is changed from (bᵢ) to (bᵢ). Second, the implicit generalized second price auction is defined by the relationship shown in Equation 2. In other words, the revenue (rᵢ) generated by a click on ad (αᵢ) is the value of the minimal bid for ad (αᵢ) that would maintain the ad (αᵢ) in the i-th position in the ad ordering as generated by applying the policy (π) to the context (x).

rᵢ(x,π)=min{b:πᵢ(x_{α,b})=αᵢ} Equation 2.

To maintain incentive compatibility in the case of a single ad to be displayed, it is stipulated that the “winning” ad be monotonic with respect to the bid of the “winning” ad. In other words, if πᵢ(x)=αᵢ, it is required that for all bids b′>b_{αi}, either πᵢ(X_{αib′})=αᵢ, or πⱼ(x_{αib′})=αᵢ for j<i. Restated, in an implicit generalized second price auction, the smallest possible bid (bᵢ) for a click on ad (αᵢ) is charged such that the ad (αᵢ) can maintain its position (i) under the policy (π) as applied to the context (x), when all other variables except for the bid (bᵢ) are held constant in the context (x). The implicit generalized second price auction ensures that the payoff (rᵢ) for the click on ad (αᵢ) does not depend on the actual bid (bᵢ), and that the payoff (rᵢ) is no larger than the actual bid (bᵢ). Also, when only one ad is displayed, the implicit generalized second price auction is incentive compatible.

To facilitate optimization of a policy to maximize revenue, a parameterized policy π₇₄ (x) is defined to include a tuning parameter θ. The expected revenue (ER_{πθ}) for the parameterized policy is shown in Equation 3. In order to find the parameter θ to optimize the total revenue (ER_{πθ}), it is only necessary to have a good estimate of the position/context/user dependent CTR probability P(cᵢ=1|x,αₗ, . . . , αₙ) for each position (i) and context (x,αₗ, . . . , αₙ).

$$E {R}_{π θ} = {\sum }_{i = 1}^{n} {E}_{x ∼ D} P ( {c}_{i} = 1 \vert x , {a}_{1} , … , {a}_{n} ) {r}_{i} ( x , {π}_{θ} ) . \qquad Equation 3$$

CTR prediction can be performed using counting-based techniques or machine learning-based techniques. When the amount of data is very large, and the context is small, the CTR probability may be estimated using the relative counts of events, such as shown in Equation 4. However, estimating CTR probability based on the relative counts of events breaks down quickly as the context (x) size increases. One approach for extending the ability to estimate the CTR probability based on the relative counts of events is to omit some context. For example, conditioning the CTR probability on just (x,αᵢ,i) may extend the ability to estimate the CTR probability based on the relative counts of events. However, when the context becomes sufficiently large, machine learning-based techniques are needed to estimate the CTR probability.

$$\hat{P} ( {c}_{i} = 1 \vert x , {a}_{1} , … , {a}_{n} ) = \frac{\vert \{ \begin{matrix}events with context \\ ( x , {a}_{1} , … , {a}_{n} ) \\ and click {c }_{i}\end{matrix} \} \vert}{\{ \begin{matrix}events with context \\ ( x , {a}_{1} , … , {a}_{n} )\end{matrix} \}} . \qquad Equation 4$$

Machine learning is a way of using past observations to predict future behavior. For example, a given ad may have been previously displayed in a particular context, and the given ad was either clicked or not. This data about the previously displayed ad can be used to predict whether a similar future ad in a similar future context will be clicked or not. In one embodiment, machine learning-based techniques for estimating the CTR probability utilize a proper scoring function defined as a loss function for which an optimizer of the loss is the probability of an event. Two types of proper scoring functions include log loss and squared loss. In one embodiment, a CTR predictor is found by creating examples ((x,i),cᵢ), and then optimizing the prediction of squared loss over some architecture. Given CTR estimates, a policy (π) is learned by optimizing Equation 3 over θ. In a custom learning algorithm, Equation 3 may be optimized by a straightforward gradient descent application.

In one embodiment, a new policy (π′) created after estimating CTR is different from the policy (π) which was used to collect data for the CTR estimate. Therefore, in this embodiment, the “test data” for the CTR predictor is drawn from a different distribution than the “training data.” In one embodiment, the difference between “test data” and “training data” is dealt with by constraining the optimization over the new policy (π′) so that it cannot differ greatly from the policy (or) used to generate the samples for the CTR predictor. In one embodiment, an iterative process for policy (π) optimization to maximize revenue includes:

(1) Use policy (π) to gather data,

(2) Use machine learning (or simple counting) to predict CTR, and

(3) Learn a new policy (π′) which replaces (π).

Based on the foregoing, a method is defined for controlling display of advertisements so as to optimize revenue generated through user-selection of the displayed advertisements. A method is also defined for selecting a policy to be used to determine an advertisement slate for display. Additionally, a method is defined for pricing a user-selected advertisement.

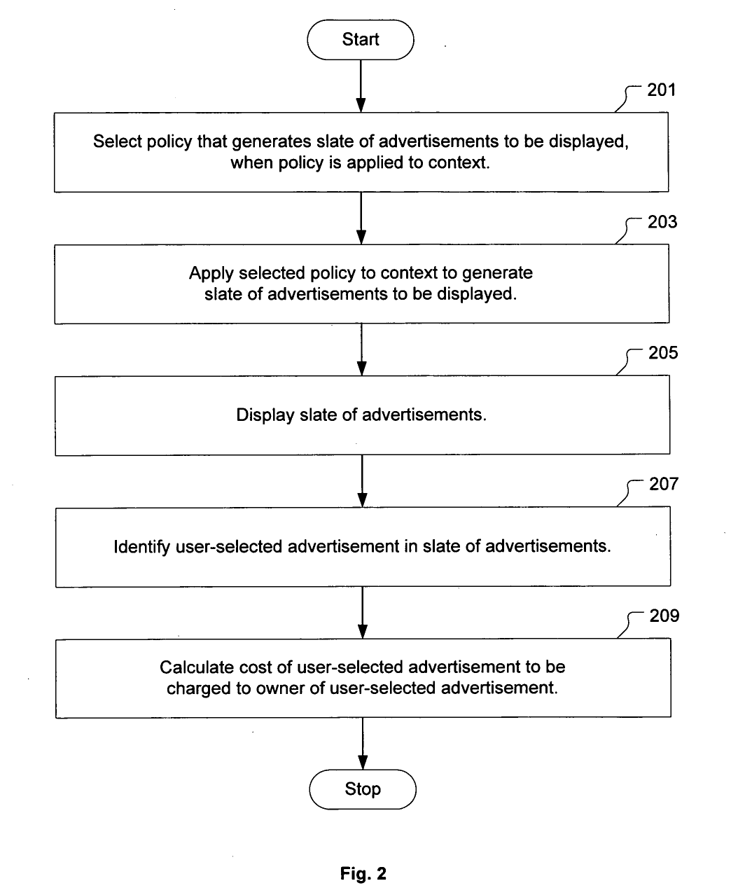

FIG. 2 is an illustration showing a flowchart of a method for controlling display of advertisements, in accordance with one embodiment of the present invention. It should be understood that the operations of the method of FIG. 2 can be implemented by a computer operating in accordance with set of suitably defined instructions. The method includes an operation 201 for selecting a policy that generates a slate of advertisements to be displayed when the policy is applied to a context. In operation 201, the policy is selected based on an expected revenue generation capability of the slate of advertisements to be generated by the policy. In one embodiment, each advertisement in the slate of advertisements has a respective bid amount, is linked to a budget, and includes some content. Also, it should be understood that in operation 201, the context is a set of available information to be operated on by the policy to generate the slate of advertisements. In one embodiment, the context includes one or more of a current query by a current user, a number of past queries by the current user, a content of each advertisement in a set of available advertisements, a location of the current user, past actions by the current user, and/or a current time.

The method also includes an operation 203 for applying the selected policy to the context to generate the slate of advertisements to be displayed. The policy operates to generate the slate of advertisements from a population of advertisements. Each advertisement in the population of advertisements has an associated revenue value defined by a bid amount of the advertisement and a relevance of the advertisement to the context. In an operation 205, the slate of advertisements is displayed.

The method proceeds with an operation 207 for identifying a user-selected advertisement in the slate of advertisements. Then, in an operation 209, a cost of the user-selected advertisement to be charged to an owner of the advertisement is calculated. The cost is calculated based on the selected policy, the context, and the slate of advertisements. In one embodiment, the cost of the user-selected advertisement is calculated to be a minimum bid amount for the user-selected advertisement that results in generation of the same slate of advertisements through application of the same selected policy to the same context. Also, a maximum cost of the user-selected advertisement does not exceed a bid amount of the user-selected advertisement.

In one embodiment, the method can further include an operation for maintaining a set of policies. Also, in this embodiment, historical data is recorded. The historical data can include previous contexts, slates of advertisements displayed in each previous context, and user-selected advertisements from each slate of advertisements displayed in each previous context. This embodiment also includes an operation for applying each policy in the set of policies to the historical data to evaluate a revenue generation capability of each policy. This embodiment further includes identifying a maximum revenue generating policy in the set of policies. The maximum revenue generating policy can be the policy selected in operation 201 to generate the slate of advertisements.

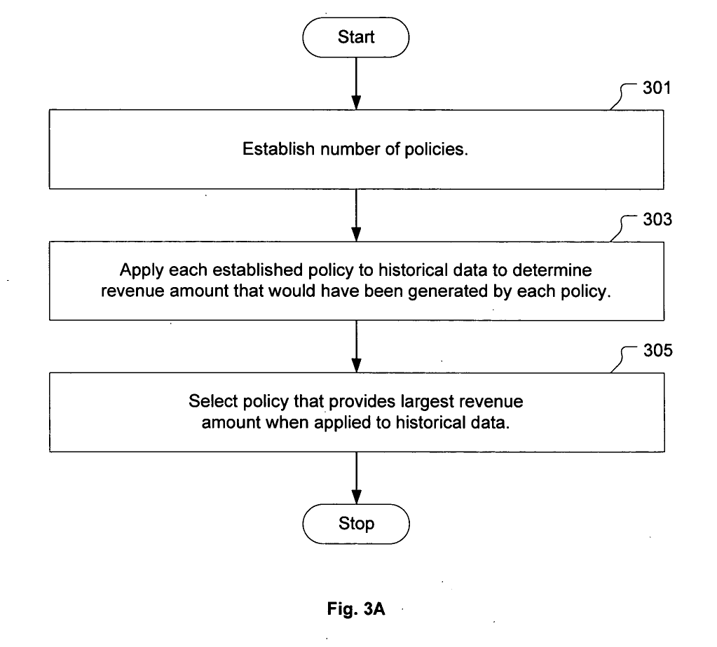

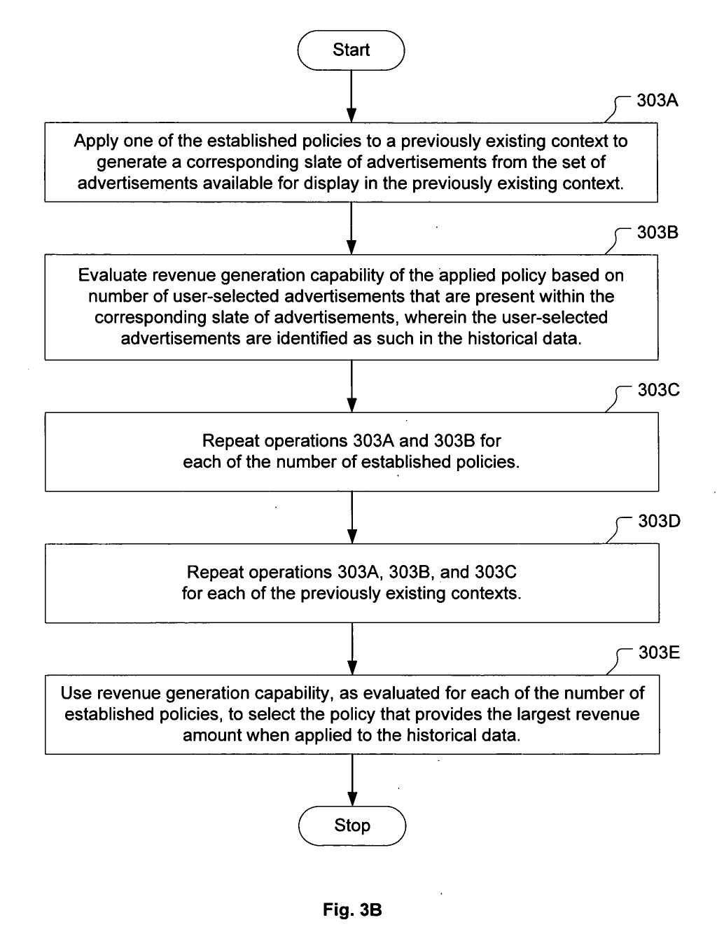

FIG. 3A is an illustration showing a flowchart of a method for selecting a policy to be used to determine an advertisement slate for display, in accordance with one embodiment of the present invention. It should be understood that the operations of the method of FIG. 3A can be implemented by a computer operating in accordance with set of suitably defined instructions. The method includes an operation 301 for establishing a number of policies. Each policy in the number of policies is defined to generate a slate of advertisements from a population of advertisements when applied to a context. In one embodiment, the context includes one or more of a current query by a current user, a number of past queries by the current user, a content of each advertisement in a set of available advertisements, a location of the current user, past actions by the current user, and/or a current time.

The method also includes an operation 303 for applying each of the number of policies to historical data to determine a revenue amount that would have been generated by each of the number of policies. In one embodiment, the historical data includes a record of previously existing contexts, a set of advertisements available for display in each previously existing context, a slate of advertisements displayed in each previously existing context, and user-selected advertisements from each displayed slate of advertisements in each previously existing context. The method further includes an operation 305 for selecting a policy, from the number of policies, that provides a largest revenue amount when applied to the historical data. The selected policy is to be used to determine an advertisement slate for display in a current context.

FIG. 3B is an illustration showing an expanded description of the operation 303 for applying each of the number of policies to historical data to determine a revenue amount that would have been generated by each of the number of policies, in accordance with one embodiment of the present invention. It should be understood that the operations of the method of FIG. 3B can be implemented by a computer operating in accordance with set of suitably defined instructions. An operation 303A is performed to apply one of the number of policies to a previously existing context to generate a corresponding slate of advertisements from the set of advertisements available for display in the previously existing context. An operation 303B is then performed to evaluate a revenue generation capability of the applied policy based on a number of user-selected advertisements that are present within the corresponding slate of advertisements, wherein the user-selected advertisements are identified as such in the historical data. An operation 303C provides for repetition of operations 303A and 303B for each of the number of policies. An operation 303D provides for repetition of operations 303A, 303B, and 303C for each of the previously existing contexts. An operation 303E is then performed to use the revenue generation capability, as evaluated for each of the number of policies, to select the policy that provides the largest revenue amount when applied to the historical data.

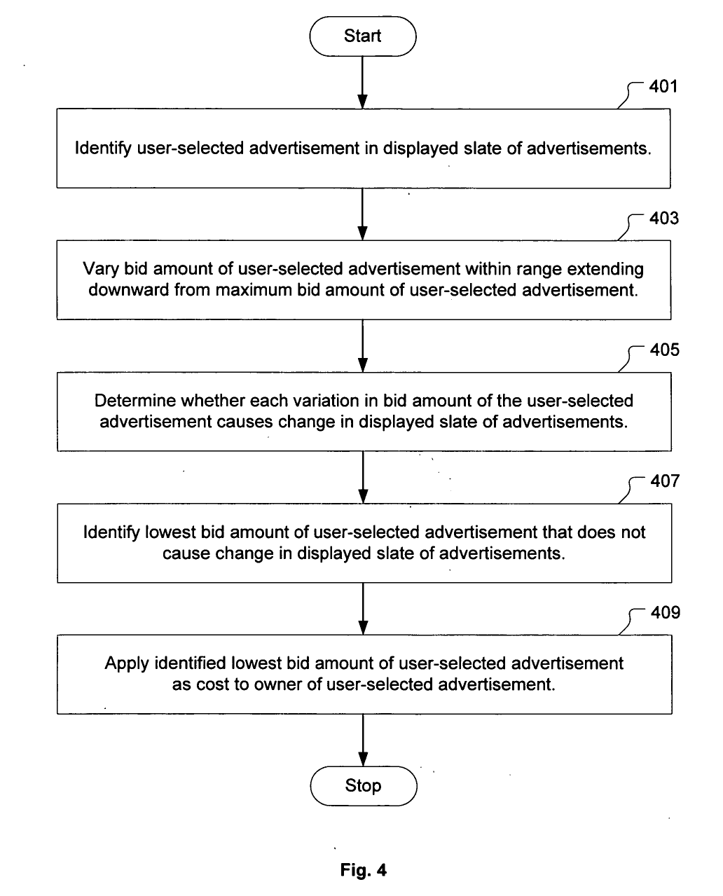

FIG. 4 is an illustration showing a flowchart of a method for pricing a user-selected advertisement, in accordance with one embodiment of the present invention. It should be understood that the operations of the method of FIG. 4 can be implemented by a computer operating in accordance with set of suitably defined instructions. The method includes an operation 401 for identifying a user-selected advertisement in a displayed slate of advertisements. The displayed slate of advertisements is selected by a policy applied to a context. The context includes a population of advertisements available for selection, and a maximum bid amount of each advertisement in the population of advertisements available for selection. The policy operates to select a slate of advertisements for display based on a revenue value for each advertisement in the population of advertisements available for selection. The revenue value of a given advertisement is defined by a bid amount of the given advertisement and a relevance of the given advertisement to the context.

The method also includes an operation 403 for varying a bid amount of the user-selected advertisement within a range extending downward from a maximum bid amount of the user-selected advertisement. The maximum bid amount is specified by an owner of the user-selected advertisement. Each parameter of the context, other than the bid amount of the user-selected advertisement, is maintained constant as the bid amount of the user-selected advertisement is varied. It should be understood that as the bid amount of the user-selected advertisement is varied, the respective bid amounts of the other advertisements in the available population are held constant. In one embodiment, the bid amount of the user-selected advertisement is varied according to a search algorithm defined to efficiently identify the lowest bid amount of the user-selected advertisement that does not cause a change in the displayed slate of advertisements.

The method further includes an operation 405 for determining whether each variation in the bid amount of the user-selected advertisement causes a change in the displayed slate of advertisements. In one embodiment, the determination of operation 405 includes applying a policy to a context to generate a test slate of advertisements, wherein the policy is equivalent to that used to generate the displayed slate of advertisements, and wherein the context is equivalent to that from which the displayed slate of advertisements is generated, except for the varying of the bid amount of the user-selected advertisement.

An operation 407 is then performed to identify, from the variations in the bid amount of operation 403, a lowest bid amount of the user-selected advertisement that does not cause a change in the displayed slate of advertisements. Then, in an operation 409, the identified lowest bid amount of the user-selected advertisement, from operation 407, is applied as a cost of the user-selected advertisement to be charged to the owner of the user-selected advertisement.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as computer readable code on a computer readable medium. The computer readable medium is any data storage device that can store data which can be thereafter read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A computer implemented method for controlling display of advertisements, comprising:
selecting a policy that generates a slate of advertisements to be displayed when the policy is applied to a context;
applying the selected policy to the context to generate the slate of advertisements to be displayed;
displaying the slate of advertisements;
identifying a user-selected advertisement in the slate of advertisements; and
calculating a cost of the user-selected advertisement to be charged to an owner of the advertisement, wherein the cost is calculated based on the selected policy, the context, and the slate of advertisements.

2. A computer implemented method for controlling display of advertisements as recited in claim 1, wherein the policy is selected based on an expected revenue generation capability of the slate of advertisements to be generated by the policy.

3. A computer implemented method for controlling display of advertisements as recited in claim 1, wherein the policy operates to generate the slate of advertisements from a population of advertisements, wherein each advertisement in the population of advertisements has an associated revenue value defined by a bid amount of the advertisement and a relevance of the advertisement to the context.

4. A computer implemented method for controlling display of advertisements as recited in claim 1, wherein each advertisement in the slate of advertisements has a respective bid amount, is linked to a budget, and includes some content.

5. A computer implemented method for controlling display of advertisements as recited in claim 1, wherein the context is a set of available information to be operated on by the policy to generate the slate of advertisements.

6. A computer implemented method for controlling display of advertisements as recited in claim 5, wherein the context includes one or more of a current query by a current user, a number of past queries by the current user, a content of each advertisement in a set of available advertisements, a location of the current user, past actions by the current user, a current time.

7. A computer implemented method for controlling display of advertisements as recited in claim 1, wherein the cost of the user-selected advertisement is calculated to be a minimum bid amount for the user-selected advertisement that results in generation of the slate of advertisements through application of the selected policy to the context.

8. A computer implemented method for controlling display of advertisements as recited in claim 7, wherein a maximum cost of the user-selected advertisement does not exceed a bid amount of the user-selected advertisement.

9. A computer implemented method for controlling display of advertisements as recited in claim 1, further comprising:
maintaining a set of policies;
recording historical data of contexts, slates of advertisements displayed in each context, and user-selected advertisements from each displayed slate of advertisements;
applying each policy in the set of policies to the historical data to evaluate a revenue generation capability of each policy; and
identifying a maximum revenue generating policy in the set of policies, wherein the maximum revenue generating policy is the policy selected to generate the slate of advertisements.

10. A computer implemented method for selecting a policy to be used to determine an advertisement slate for display, comprising:
establishing a number of policies;
applying each of the number of policies to historical data to determine a revenue amount that would have been generated by each of the number of policies; and
from the number of policies, selecting a policy that provides a largest revenue amount when applied to the historical data, wherein the selected policy is to be used to determine an advertisement slate for display in a current context.

11. A computer implemented method for selecting a policy to be used to determine an advertisement slate for display as recited in claim 10, wherein each policy in the number of policies is defined to generate a slate of advertisements from a population of advertisements when applied to a context, wherein the context includes one or more of a current query by a current user, a number of past queries by the current user, a content of each advertisement in a set of available advertisements, a location of the current user, past actions by the current user, a current time.

12. A computer implemented method for selecting a policy to be used to determine an advertisement slate for display as recited in claim 10, wherein historical data includes a record of previously existing contexts, a set of advertisements available for display in each previously existing context, a slate of advertisements displayed in each previously existing context, and user-selected advertisements from each displayed slate of advertisements in each previously existing context.

13. A computer implemented method for selecting a policy to be used to determine an advertisement slate for display as recited in claim 12, wherein applying each of the number of policies to historical data to determine the revenue amount that would have been generated by each of the number of policies includes,
(a) applying one of the number of policies to a previously existing context to generate a corresponding slate of advertisements from the set of advertisements available for display in the previously existing context,
(b) evaluating a revenue generation capability of the applied policy based on a number of user-selected advertisements that are present within the corresponding slate of advertisements, wherein the user-selected advertisements are identified as such in the historical data,
(c) repeating (a) and (b) for each of the number of policies,
(d) repeating (a), (b), and (c) for each of the previously existing contexts, and
(e) using the revenue generation capability as evaluated for each of the number of policies to select the policy that provides the largest revenue amount when applied to the historical data.

14. A computer implemented method for pricing a user-selected advertisement, comprising:
identifying a user-selected advertisement in a displayed slate of advertisements;
varying a bid amount of the user-selected advertisement within a range extending downward from a maximum bid amount of the user-selected advertisement, wherein the maximum bid amount is specified by an owner of the user-selected advertisement;
determining whether each variation in the bid amount of the user-selected advertisement causes a change in the displayed slate of advertisements;
from the variations in the bid amount, identifying a lowest bid amount of the user-selected advertisement that does not cause a change in the displayed slate of advertisements; and
assigning the identified lowest bid amount of the user-selected advertisement as a cost of the user-selected advertisement to be charged to the owner of the user-selected advertisement.

15. A computer implemented method for pricing a user-selected advertisement as recited in claim 14, wherein the displayed slate of advertisements is selected by a policy applied to a context, wherein the context includes a population of advertisements available for selection, and a maximum bid amount of each advertisement in the population of advertisements available for selection.

16. A computer implemented method for pricing a user-selected advertisement as recited in claim 15, wherein the policy operates to select a slate of advertisements for display based on a revenue value for each advertisement in the population of advertisements available for selection, wherein the revenue value of a given advertisement is defined by a bid amount of the given advertisement and a relevance of the given advertisement to the context.

17. A computer implemented method for pricing a user-selected advertisement as recited in claim 15, further comprising:
maintaining constant each parameter of the context other than the bid amount of the user-selected advertisement, as the bid amount of the user-selected advertisement is varied.

18. A computer implemented method for pricing a user-selected advertisement as recited in claim 17, wherein each parameter of the context other than the bid amount, includes a respective bid amount of each advertisement in the population of advertisements available for selection other than the user-selected advertisement.

19. A computer implemented method for pricing a user-selected advertisement as recited in claim 14, wherein determining whether each variation in the bid amount of the user-selected advertisement causes a change in the displayed slate of advertisements includes applying a policy to a context to generate a test slate of advertisements, wherein the policy is equivalent to that used to generate the displayed slate of advertisements, and wherein the context is equivalent to that from which the displayed slate of advertisements is generated except for the varying of the bid amount of the user-selected advertisement.

20. A computer implemented method for pricing a user-selected advertisement as recited in claim 14, wherein the bid amount of the user-selected advertisement is varied according to a search algorithm defined to efficiently identify the lowest bid amount of the user-selected advertisement that does not cause a change in the displayed slate of advertisements.
